(19) United States
(12) Patent Application Publication
(10) Pub. No.: US 2016/0226148 A1
(43) Pub. Date: Aug. 4, 2016

(54) LAMINATED WAVEGUIDE, WIRELESS MODULE, AND WIRELESS SYSTEM

(71) Applicant: FUJITSU LIMITED, Kawasaki-shi (JP)

(72) Inventors: Hiroshi ASHIDA, Fujisawa (JP); Yoji OHASHI, Fucyu (JP)

(21) Appl. No.: 14/975,443

(22) Filed: Dec. 18, 2015

(30) Foreign Application Priority Data
Feb. 4, 2015 (JP) 2015-020431

(51) Int. Cl. H01Q 9/04; H01Q 1/38

(52) U.S. Cl. CPC H01Q 9/0407; H01Q 1/38

(57) ABSTRACT

A laminated waveguide includes: a dielectric layer, a first and a second patch antennae formed on a first face of the dielectric layer, a third and a fourth patch antennae formed on a second face of the dielectric layer, the first face being opposite to the second surface, a first and a second transmission lines formed on the dielectric layer and connected to the first and the second patch antennae, respectively, a third and a fourth transmission lines formed on the dielectric layer and connected to the third and the fourth patch antennae, respectively, wherein a pair of the first and the third patch antennae and another pair of the second and the fourth patch antennae are arranged to form an angle between the pair and the another pair so as to suppress interference between the pair and the another pair.

### CROSS-REFERENCE TO RELATED APPLICATION

This application is based upon and claims the benefit of priority of the prior Japanese Patent Application No. 2015-020431, filed on Feb. 4, 2015, the entire contents of which are incorporated herein by reference.

### FIELD

The embodiments discussed herein are related to a laminated waveguide, a wireless module, and a wireless system.

### BACKGROUND

Conventionally, there has been a planar antenna module comprising an antenna section, a feedline section, and a connected conductor. The antenna section includes a first ground conductor having a first slot, a second ground conductor having a dielectric, an antenna substrate having a radiating element, a third ground conductor having a dielectric, and a fourth ground conductor. The feedline section includes the fourth ground conductor, a fifth ground conductor, a feed substrate, a sixth ground conductor, and a seventh ground conductor, and the connected conductor includes a second waveguide opening. The planar antenna module is formed by laminating a connection conductor with a high frequency circuit, the seventh ground conductor, the sixth ground conductor, the feed substrate, the fifth ground conductor, the fourth ground conductor, the third ground conductor, the antenna substrate, the second ground conductor, and the first ground conductor in this order (See International Publication Pamphlet No. WO 2006/098054).

Incidentally, since a conventional planar antenna module has a complicated structure and desires high-precision positioning when the planar antenna module is assembled, there is a problem that manufacturing cost is expensive.

Hence, an objective is to provide a laminated waveguide, a wireless module, and a wireless system that reduce the manufacturing cost.

### SUMMARY

According to an aspect of the invention, a laminated waveguide includes: a dielectric layer, a first and a second patch antennae formed on a first face of the dielectric layer, a third and a fourth patch antennae formed on a second face of the dielectric layer, the first face being opposite to the second surface, a first and a second transmission lines formed on the dielectric layer and connected to the first and the second patch antennae, respectively, a third and a fourth transmission lines formed on the dielectric layer and connected to the third and the fourth patch antennae, respectively, wherein a pair of the first and the third patch antennae and another pair of the second and the fourth patch antennae are arranged to form an angle between the pair and the another pair so as to suppress interference between the pair and the another pair.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating a wireless communication module including a laminated waveguide of an embodiment 1, and a wireless communication system;

FIG. 2 is a perspective view illustrating the laminated waveguide of the embodiment 1;

FIG. 3 is a view illustrating an exploded state of the laminated waveguide illustrated in FIG. 2;

FIG. 4 is a top view illustrating the laminated waveguide;

FIG. 5 is a view illustrating a cross section taken along the arrow V-V in FIG. 4;

FIGS. 6A and 6B are views illustrating a simulation model of the laminated waveguide;

FIGS. 7A, 7B, and 7C are diagrams illustrating simulation results of S parameters and bandwidths;

FIGS. 8A and 8B are views illustrating distribution of an electric field in a model used in the simulation;

FIGS. 9A, 9B, and 9C are diagrams illustrating dependence of a resonant frequency, the S parameters, and bandwidths on a combination of length and diameter;

FIG. 10 is a perspective view illustrating a laminated waveguide of an embodiment 2;

FIG. 11 is a view illustrating an exploded state of the laminated waveguide illustrated in FIG. 10;

FIG. 12 is a top view illustrating the laminated waveguide;

FIG. 13 is a view illustrating a cross section taken along the arrow XIII-XIII in FIG. 12;

FIGS. 14A and 14B are views illustrating a simulation model of the laminated waveguide;

FIG. 15 is a characteristic diagram illustrating a relationship between dimensions of a patch antenna and input impedance;

FIG. 16 is a diagram summarizing in a tabular format simulation results obtained when width is changed;

FIG. 17 is a graph illustrating frequency characteristics of S11 parameter, S21 parameter, S41 parameter, and S42 parameter in the laminated waveguide;

FIGS. 18A and 18B are views illustrating a simulation model of a laminated waveguide according to a variant of the embodiment 2;

FIG. 19 is a diagram summarizing in a tabular format simulation results when the width is changed in the laminated waveguide of the variant of the embodiment 2;

FIG. 20 is a graph illustrating frequency characteristics of the S11 parameter, the S21 parameter, the S41 parameter, and the S42 parameter when the width is set to 0.49 mm in the laminated waveguide of the variant of the embodiment 2; and

FIG. 21 is a view illustrating a configuration of a laminated waveguide according to the variant of the embodiment 2.

### DESCRIPTION OF EMBODIMENTS

Embodiments to which a laminated waveguide, a wireless module, and a wireless system of the present disclosure are applied are described hereinafter.

### Embodiment 1

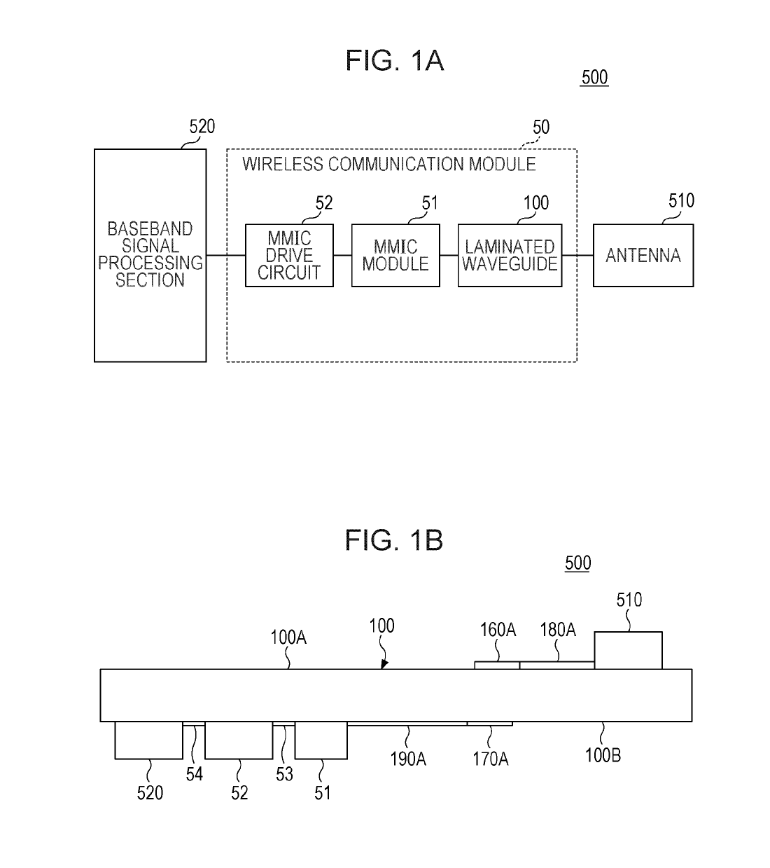

FIGS. 1A and 1B are diagrams illustrating a wireless communication module 50 including a laminated waveguide 100 of embodiment 1, and a wireless communication system 500. FIG. 1A is a block diagram and FIG. 1B is a side view illustrating an example of an installation state.

As illustrated in FIG. 1A, the wireless communication system 500 has an antenna 510, the wireless communication module 50, and a baseband signal processing section 520.

The wireless communication module 50 includes the laminated waveguide 100, a monolithic microwave integrated circuit (MMIC) module 51, and an MMIC drive circuit 52.

The MMIC module 51 is a device connected to the laminated waveguide 100 and configured to perform wireless front-end processing. In the MMIC module 51, an amplifier, a mixer, an oscillator (voltage-controlled oscillator: VCO), a multiplexer and the like are integrated. The MMIC module 51 is configured to generate a high-frequency signal of a millimeter waveband (hereinafter referred to as a millimeter wave) transmitted from the antenna 510 and extract a difference between a reflection signal received by the antenna 510 and a transmitted high-frequency signal.

The MMIC drive circuit 52 is a circuit configured to drive the MMIC module 51.

The baseband signal processing section 520 processes a low-frequency component corresponding to the difference in frequencies to retrieve desired information. The baseband signal processing section 520 is an example of the signal processing section.

The laminated waveguide 100 of the wireless communication module 50 has a simple configuration, low transmission loss, and good isolation characteristics, which thus allows downsizing of the wireless communication module 50 and cost reduction to be achieved.

In addition, using another different wireless communication system 500, the wireless communication system 500 may perform communications in millimeter waves between the two wireless communication systems 500. The communications in millimeter waves may narrow directivity, thus easily enabling multiple channels.

In addition, the wireless communication system 500 may be used as a radar device. A distance to an object may be measured based on a time difference between a radio wave that the wireless communication system 500 emits from the antenna 510 and a radio wave that is reflected and then received. In addition, if the laminated waveguide 100 has waveguides for multiple channels and the wireless communication system 500 includes antennae 510 for the multiple channels, a distance to an object is measured by the multiple antennae 510 aligned in parallel, thereby allowing a direction in which the object is located to be detected based on a difference in the distance.

In addition, as illustrated in FIG. 1B, in the wireless communication system 500, by way of example, the antenna 510 is mounted on one surface 100A of the laminated waveguide 100, and the MMIC module 51, the MMIC drive circuit 52, and the baseband signal processing section 520 are mounted on other surface 100B.

The laminated waveguide 100 includes patch antennae 160A, 170A and transmission lines 180A, 190A. The patch antenna 160A and the transmission line 180A are formed on the surface 100A. The patch antenna 160A is connected to the antenna 510 through the transmission line 180A.

The patch antenna 170A and the transmission line 190A are formed on the surface 100B. The patch antenna 170A is connected to the MMIC module 51 through the transmission line 190A. The MMIC module 51 is connected to the MMIC drive circuit 52 through a wiring layer 53 formed on the surface 100B, and the MMIC drive circuit 52 is connected to the baseband signal processing section 520 through a wiring layer 54 formed on the surface 100B.

Since the patch antennae 160A and 170A build a waveguide, the antenna 510 and the MMIC module 51 are connected through the waveguide built by the patch antennae 160A and 170A.

Now, the antenna 510 is mounted on the opposite side of the laminated waveguide 100 to the MMIC module 51 and the MMIC drive circuit 52 because it is intended not to allow the antenna 510 to receive a high-frequency signal generated by the MMIC module 51 and the MMIC drive circuit 52.

For example, even if the transmission lines 180A and 190A are connected by using a general wiring substrate instead of the laminated waveguide 100 and a contact plug or the like instead of the patch antennae 160A and 170A, it is still difficult to transmit a millimeter wave through the contact plug or the like.

For these reasons, the laminated waveguide 100 wherein the patch antenna 160A on the side of the surface 100A and the patch antenna 170A on the side of the surface 100B build the waveguide is used.

A configuration of the laminated waveguide 100 is described hereinafter.

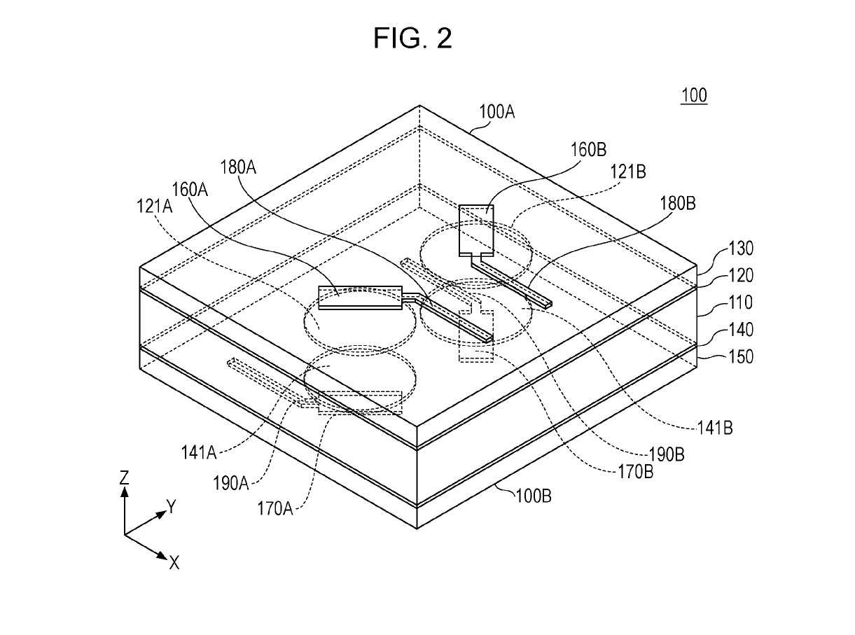

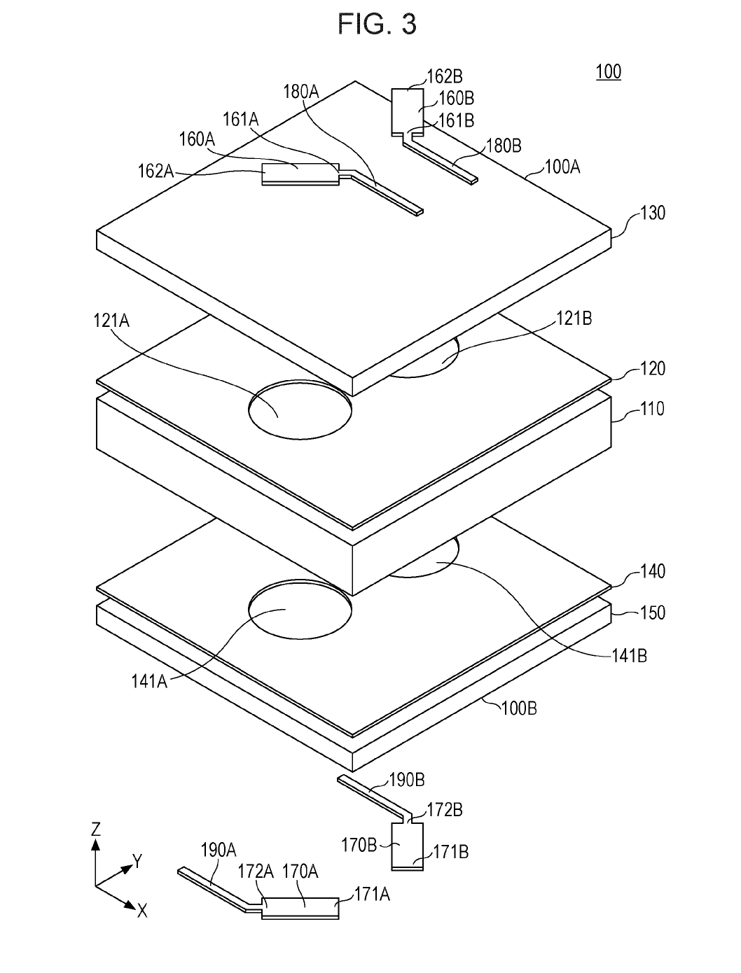

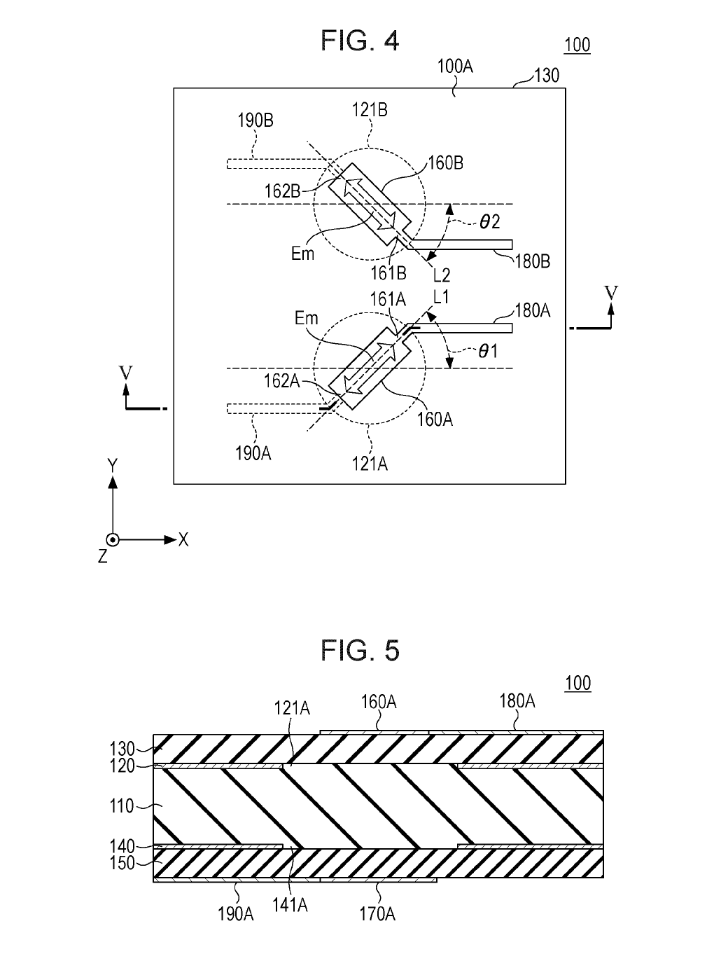

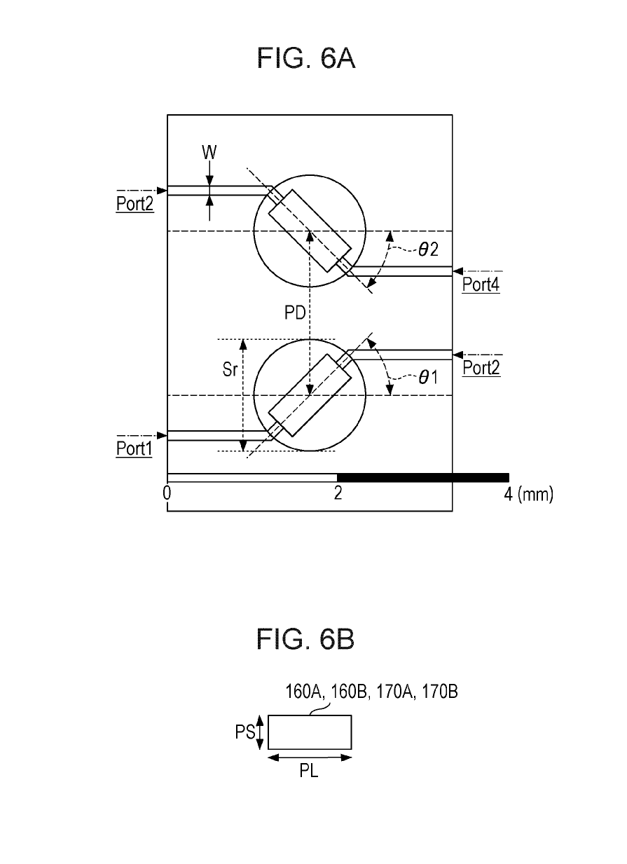

FIG. 2 is a perspective view illustrating the laminated waveguide 100 of the embodiment 1. FIG. 3 is a view illustrating an exploded state of the laminated waveguide 100 illustrated in FIG. 2. FIG. 4 is a top view illustrating the laminated waveguide 100. FIG. 5 is a view illustrating a cross section taken along the arrow V-V in FIG. 4. Note that an XYZ coordinate system (orthogonal coordinate system) is defined below, as illustrated in FIGS. 2 to 5.

The laminated waveguide 100 includes a dielectric layer 110, a conductive layer 120, a dielectric layer 130, a conductive layer 140, a dielectric layer 150, patch antennae 160A, 160B, 170A, 170B, and transmission lines 180A, 180B, 190A, 190B.

Here, a mode in which the dielectric layer 110, the conductive layer 120, the dielectric layer 130, the conductive layer 140, the dielectric layer 150, the patch antennae 160A, 160B, 170A, 170B, and the transmission lines 180A, 180B, 190A, 190B are achieved by a wiring substrate of the flame retardant 4 (FR4) standard is described.

FIGS. 2 to 5 illustrate a part of the dielectric layer 110, the conductive layer 120, the dielectric layer 130, the conductive layer 140, and the dielectric layer 150 to be achieved by the wiring substrate. More specifically, the dielectric layer 110, the conductive layer 120, the dielectric layer 130, the conductive layer 140, and the dielectric layer 150 actually extends more in the X-axis direction and the Y-axis direction than a rectangular part illustrated in a plan view in FIGS. 2 to 5.

The dielectric layer 110 is made of a dielectric (insulator). The dielectric layer 110 is an example of a first dielectric layer. As the dielectric layer 110, a core material, fiberglass is impregnated with epoxy resin fiberglass, may be used. The conductive layers 120 and 140 are formed on both sides of the dielectric layer 110 as the core material.

The conductive layer 120 is provided on a surface on the side in the positive Z-axis direction of the dielectric layer 110. The conductive layer 120 is an example of a first conductive layer. The conductive layer 120 may be made of metal such as copper or aluminum or the like. As described above, when a core material is used as the dielectric layer 110, copper foil or the like attached to one side of the core material (surface on the side in the positive Z-axis direction) may be used as the conductive layer 120.

The conductive layer 120 has slots 121A, 121B. The slots 121A, 121B are respectively an example of a first slot and a second slot. The slots 121A, 121B are circular in a plan view and openings penetrating through the conductive layer 120 in the thickness direction (Z-axis direction). Diameters of the slots 121A, 121B are equal to each other.

The slots 121A, 121B may be formed by patterning the copper foil attached to the surface on the side in the positive Z-axis direction of the core material as the dielectric layer 110, for example, with the photolithography method and the wet etching method.

By way of example, the slots 121A and 121B are located such that the center point of width of the conductive layer 120 in the Y-axis direction coincides with the center point between the openings and such that the slots are symmetrical with respect to a line, as an axis of symmetry, passing in the Y-axis direction through the center point of the width of the conductive layer 120 in the X-axis direction.

The dielectric layer 130 is made of a dielectric (insulator) and laminated in the positive Z-axis direction of the conductive layer 120. The dielectric layer 130 is an example of a second dielectric layer. As described above, when a core material is used as the dielectric layer 110, a prepreg layer, in which fiberglass is impregnated with epoxy resin, for example, may be used as the dielectric layer 130.

The conductive layer 140 is provided on a surface on the side in the negative Z-axis direction of the dielectric layer 110. The conductive layer 140 is an example of a second conductive layer. The conductive layer 140 may be made of metal such as copper or aluminum or the like. As described above, when a core material is used as the dielectric layer 110, copper foil attached to the surface on the side in the negative Z-axis direction of the core material may be used as the conductive layer 140.

The conductive layer 140 has slots 141A, 141B. The slots 141A, 141B are respectively an example of a third slot and a fourth slot. The slots 141A, 141B are circular in a plan view and openings penetrating through the conductive layer 140 in the thickness direction (Z-axis direction). Diameters of the slots 141A, 141B are equal to diameters of the slots 121A, 121B formed on the conductive layer 120.

The slots 141A, 141B may be formed by patterning the copper foil attached to the surface on the side in the negative Z-axis direction of the core material as the dielectric layer 110, for example, with the photolithography method and the wet etching method.

By way of example, the slots 141A and 141B are located such that the center point of width of the conductive layer 120 in the Y-axis direction coincides with the center point between the openings and such that the slots are symmetrical with respect to a line, as an axis of symmetry, passing in the Y-axis direction through the center point of the width of the conductive layer 120 in the X-axis direction.

More specifically, the slots 141A, 141B are aligned respectively with the slots 121A, 121B in a plan view. In other words, the slots 141A, 141B are respectively formed at positions corresponding to the slots 121A, 121B in a plan view.

The dielectric layer 150 is made of a dielectric (insulator), similarly to the dielectric layer 130, and laminated in the negative Z-axis direction of the conductive layer 140. The dielectric layer 150 is an example of a third dielectric layer. As described above, when a core material is used as the dielectric layer 110, a prepreg layer, in which fiberglass is impregnated with epoxy resin, for example, may be used as the dielectric layer 150.

The patch antennae 160A, 160B are respectively located within the slots 121A, 121B on the surface on the side in the positive Z-axis direction of the dielectric layer 130, in a plan view. The patch antennae 160A, 160B are respectively an example of a first patch antenna and a second patch antenna. The patch antennae 160A, 160B may be made of metal such as copper or aluminum or the like.

As described above, when a core material is used as the dielectric layer 110, the patch antennae 160A, 160B may be formed by patterning copper foil attached to a surface on the side in the positive Z-axis direction of the dielectric layer 130, for example, with the photolithography method and the wet etching method.

The patch antenna 160A is oblong (rectangle) in a plan view, and a length of the longitudinal direction is set to an electrical length that is half of a wavelength λ (λ/2) in a resonant frequency. The patch antenna 160A is formed such that angle θ1 which a center axis L1 parallel to the longitudinal direction forms to the X-axis is 45 degrees.

Similarly, the patch antenna 160B is oblong (rectangle) in a plan view and a length of the longitudinal direction is set to an electrical length that is half of a wavelength λ (λ/2) in a resonant frequency. The patch antenna 160B is formed such that angle θ2 which a center axis L2 parallel to the longitudinal direction forms to the X-axis is 45 degrees.

The angle θ1 is an angle in a direction rotating anti-clockwise with respect to the X-axis and the angle θ2 is an angle in a direction rotating clockwise with respect to the X-axis. Thus, the patch antennae 160A and 160B are in a positional relation in which the center axes L1, L2 are rotated 45 degrees in opposite directions to each other, with respect to the X-axis.

In addition, the transmission line 180A is connected to an end section 161A of the patch antenna 160A in the longitudinal direction. Since the end section 161A is located on the center axis L1, the end section 161A is located at the center between edge sides of the patch antenna 160A in the short direction (direction orthogonal to the longitudinal direction in a plan view). Here, an end section on the opposite side to the end section 161A in the longitudinal direction is an end section 162A.

Since the patch antenna 160A has a configuration described above, the end section 161A serves as a power feed point when power is fed to the patch antenna 160A from the transmission line 180A. In addition, an electric field in the end sections 161A and 162A is largest at this moment, and an electric field at a mid-point between the end sections 161A and 162A is zero.

More specifically, the patch antenna 160A emits in the Z-axis direction a sine wave-like radio wave amplitude of which changes in a direction of the center axis L1 connecting the end sections 161A and 162A.

In addition, the transmission line 180B is connected to an end section 161B of the patch antenna 160B in the longitudinal direction. Since the end section 161B is located on the center axis L2, the end section 161B is located at the center edge sides of the patch antenna 160B in the short direction (direction orthogonal to the longitudinal direction in a plan view). Here, an end section on the opposite side to the end section 161B in the longitudinal direction is an end section 162B.

The patch antenna 160B is similar to the patch antenna 160A except that the angle θ2 to the X-axis is different from the angle θ1 of the patch antenna 160A. Thus, the end section 161B serves as a power feed point when power is fed to the patch antenna 160B from the transmission line 180B. In addition, an electric field in the end sections 161B and 162B is largest at this moment, and an electric field at a mid-point between the end sections 161B and 162B is zero.

More specifically, the patch antenna 160B emits in the Z-axis direction a radio wave amplitude of which changes in a direction of the center axis L2 connecting the end sections 161B and 162B.

When power is fed to the patch antennae 160A, 160B as described above, an electric field Em in directions in which the center axes L1, L2 extend is generated on the patch antennae 160A, 160B.

The patch antennae 170A, 170B are respectively located within the slots 141A, 141B on the surface on the side in the negative Z-axis direction of the dielectric layer 150, in a plan view. The patch antennae 170A, 170B are respectively an example of a third patch antenna and a fourth patch antenna. The patch antennae 170A, 170B may be made of metal such as copper or aluminum or the like.

As described above, when a core material is used as the dielectric layer 110, the patch antennae 170A, 170B may be formed by patterning copper foil attached to a surface on the side in the negative Z-axis direction of the dielectric layer 150, for example, with the photolithography method and the wet etching method.

The patch antenna 170A is oblong (rectangle) in a plan view, and a length of the longitudinal direction is set to an electrical length that is half of a wavelength λ (λ/2) in a resonant frequency. The patch antenna 170A is equal in size to the patch antenna 160A in a plan view and a position on an XY plane is equal to that of the patch antenna 160A. More specifically, the patch antenna 170A coincides with the patch antenna 160A in a plan view.

Thus, the patch antenna 170A is formed such that an angle which a center axis parallel to the longitudinal direction (center axis coinciding with the center axis L1 in a plan view) forms to the X-axis is 45 degrees.

Similarly, the patch antenna 170B is oblong (rectangle) in a plan view, and a length of the longitudinal direction is set to an electrical length that is half of a wavelength λ (λ/2) in a resonant frequency. The patch antenna 170B is equal in size to the patch antenna 160B in a plan view and a position on an XY plane is equal to that of the patch antenna 160B. More specifically, the patch antenna 170B coincides with the patch antenna 160B in a plan view.

Thus, the patch antenna 170B is formed such that an angle which a center axis parallel to the longitudinal direction (center axis coinciding with the center axis L2 in a plan view) forms to the X-axis is 45 degrees.

More specifically, the patch antennae 170A and 170B are in a positional relation in which the center axes parallel to the longitudinal directions are rotated 45 degrees in opposite directions to each other, with respect to the X-axis.

Here, both end sections of the patch antenna 170A in the longitudinal direction, which are at the same positions in a plan view as the end sections 161A, 162A of the patch antenna 160A, are end sections 171A, 172A. Similarly, both end sections of the patch antenna 170B in the longitudinal direction, which are at the same positions in a plan view as the end sections 161B, 162B of the patch antenna 160B, are end sections 171B, 172B.

The transmission line 190A is connected to the end section 172A of the patch antenna 170A in the longitudinal direction (See FIG. 3). Since the end section 172A is located on a center axis parallel to the longitudinal direction, the end section 172A is located at the center between edge sides of the patch antenna 170A in the short direction (direction orthogonal to the longitudinal direction in a plan view).

Since the patch antenna 170A has a configuration as described above, the end section 172A serves as a power feed point when power is fed to the patch antenna 170A from the transmission line 190A. In addition, an electric field in the end sections 171A and 172A is largest at this moment, and an electric field at a mid-point between the end sections 171A and 172A is zero.

More specifically, the patch antenna 170A emits in the Z-axis direction a sine wave-like radio wave amplitude of which changes in a direction of the center axis connecting the end sections 171A and 172A. Accordingly, the patch antenna 170A can communicate with the patch antenna 160A. In addition, positioning the patch antennae 160A and 170A so that the patch antennae 160A and 170A correspond to each other at the same angle and fit within the slots 121A, 141A makes communications in a radiated electromagnetic field efficient and easy to perform.

In addition, the transmission line 190B is connected to the end section 172B of the patch antenna 170B in the longitudinal direction. Since the end section 172B is located on a center axis parallel to the longitudinal direction, the end section 172B is located at the center between edge sides of the patch antenna 170B in the short direction (direction orthogonal to the longitudinal direction in a plan view).

The end section 172B serves as a power feed point when power is fed to the patch antenna 170B from the transmission line 190B. In addition, an electric field in the end sections 171B and 172B is largest at this moment, and an electric field at a mid-point between the end sections 171B and 172B is zero.

More specifically, the patch antenna 170B emits in the Z-axis direction a radio wave amplitude of which changes in a direction of the center axis connecting the end sections 171B and 172B. Accordingly, the patch antenna 170B can communicate with the patch antenna 160B. In addition, positioning the patch antennae 160B and 170B so that the patch antennae 160B and 170B correspond to each other at the same angle and fit within the slots 121B, 141B makes communications in a radiated electromagnetic field efficient and easy to perform. One ends of the transmission lines 180A, 180B are respectively connected to the end sections 161A, 161B of the patch antennae 160A, 160B. In addition, other ends of the transmission lines 180A, 180B are connected to an antenna device or an integrated circuit, or the like. The transmission lines 180A, 180B are respectively an example of a first transmission line and a second transmission line. Note that the antenna device or the integrated circuit or the like connected to the other ends of the transmission lines 180A, 180B are omitted in FIGS. 2 to 5.

The transmission lines 180A, 180B are laminated on the conductive layer 120 with the dielectric layer 130 in between and build a microstrip line with the conductive layer 120. Characteristic impedance of the transmission lines 180A, 180B is set to 50Ω, by way of example. A length between one ends and other ends of the transmission lines 180A, 180B is set to an electrical length that is half of a wavelength λ (λ/2) in a resonant frequency of the patch antennae 160A, 160B.

One ends of the transmission lines 190A, 190B are respectively connected to the end sections 172A, 172B of the patch antennae 170A, 170B. In addition, other ends of the transmission lines 190A, 190B are connected to a circuit that generates a high-frequency signal, or the like. The transmission lines 190A, 190B are respectively an example of a third transmission line and a fourth transmission line. Note that the circuit that is connected to the other ends of the transmission lines 190A, 190B and generates a high-frequency signal, or the like is omitted in FIGS. 2 to 5.

The transmission lines 190A, 190B are laminated on the conductive layer 140 with the dielectric layer 150 in between and build a microstrip line with the conductive layer 140. Characteristic impedance of the transmission lines 190A, 190B is set to 50Ω, by way of example. A length between one ends and other ends of the transmission lines 190A, 190B is set to an electrical length that is half of a wavelength λ (λ/2) in a resonant frequency of the patch antennae 170A, 170B.

In the laminated waveguide 100 having the configuration as described above, a direction of amplitude of a radio wave emitted by the patch antenna 160A in the Z-axis direction is the direction which forms the angle θ1 (45 degrees) in an anticlockwise direction to the X-axis in a plan view, and a direction of amplitude of a radio wave emitted by the patch antenna 160B in the Z-axis direction is the direction which forms the angle θ2 (45 degrees) in a clockwise direction to the X-axis in a plan view.

In addition, the direction of the amplitude of the radio wave emitted by the patch antenna 170A in the Z-axis direction is equal to the direction of the amplitude of the radio wave emitted by the patch antenna 160A in the Z-axis direction, and the direction of the amplitude of the radio wave emitted by the patch antenna 170B in the Z-axis direction is equal to the direction of the amplitude of the radio wave emitted by the patch antenna 160B in the Z-axis direction.

Thus, an angle made by the direction of the amplitude of the radio wave emitted by the patch antennae 160A and 170A and the direction of the amplitude of the radio wave emitted by the patch antennae 160B and 170B is 90 degrees. More specifically, the direction of the amplitude of the radio wave emitted by the patch antennae 160A and 170A is orthogonal to the direction of the amplitude of the radio wave emitted by the patch antennae 160B and 170B.

Here, as described above, the direction of the amplitude of the radio wave emitted by the patch antennae 160A and 170A is orthogonal to the direction of the amplitude of the radio wave emitted by the patch antennae 160B and 170B.

Therefore, even when a radio wave emitted by the patch antennae 160A and 170A leaks to the patch antennae 160B and 170B, it is possible to avoid reception of the radio wave by the patch antennae 160B and 170B.

Conversely, even when a ratio wave emitted by the patch antennae 160B and 170B leaks to the patch antennae 160A and 170A, it is possible to avoid reception of the radio wave by the patch antennae 160A and 170A.

More specifically, the patch antennae 160A and 170A, and the patch antennae 160B and 170B being positioned such that amplitude directions of electric fields are orthogonal to each other in a plan view, isolation of a waveguide built by the patch antennae 160A and 170A from a waveguide built by the patch antennae 160B and 170B is improved.

With such a configuration, interference of a radio wave being transmitted through the waveguide of the patch antennae 160A and 170A with a radio wave being transmitted through the waveguide of the patch antennae 160B and 170B is suppressed.

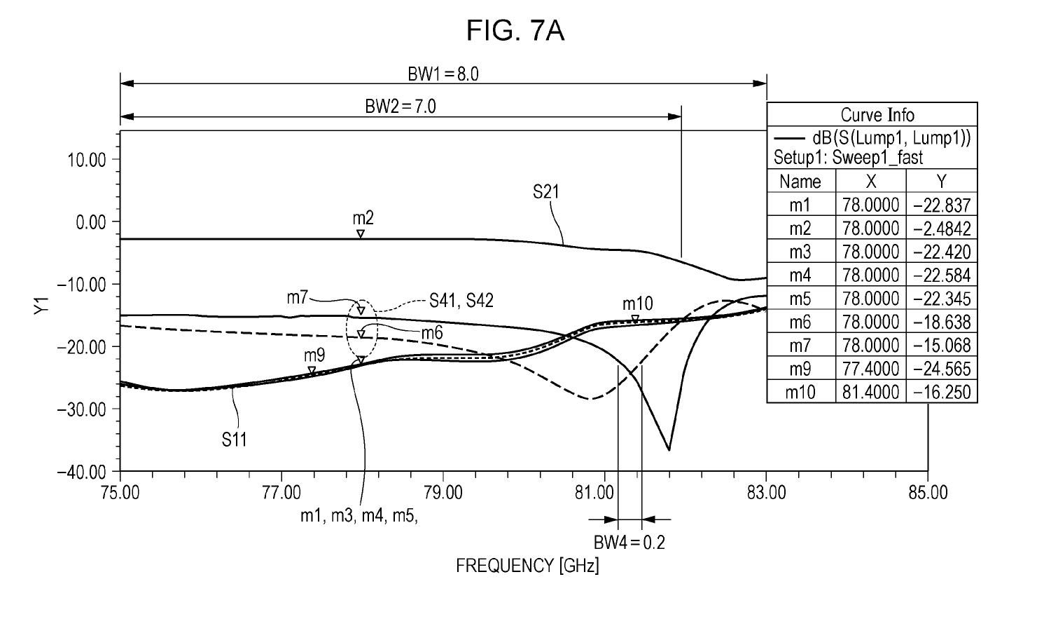

Simulation results are described hereinafter with reference to FIGS. 6A to 9C.

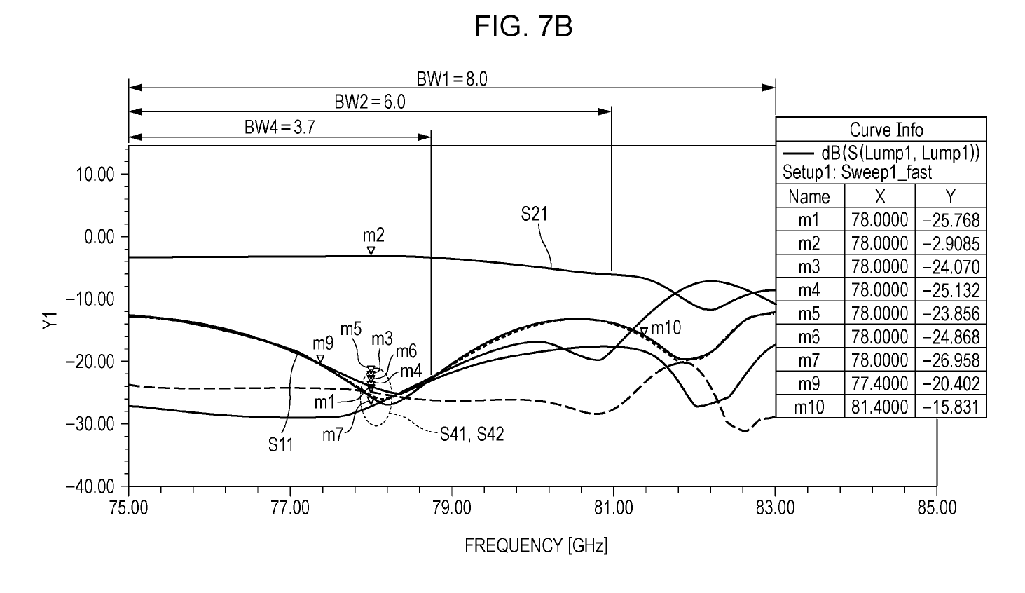

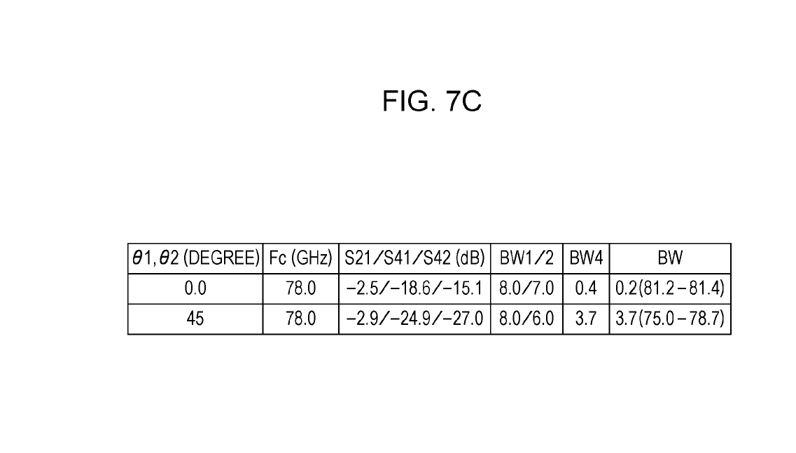

FIGS. 6A and 6B are views illustrating a simulation model of the laminated waveguide 100. FIGS. 7A, 7B, and 7C are diagrams illustrating simulation results of S parameters and bandwidths. FIGS. 8A and 8B are views illustrating distribution of an electric field in a model used in the simulation.

As illustrated in FIG. 6A, a diameter of the slots 121A, 121B, 141A, 141B is Sr, a distance between the centers of the slots 121A and 121B is PD, and line width of the transmission lines 180A, 180B, 190A, 190B is W. Note that angles θ1, θ2 are the same as those illustrated in FIG. 4.

In addition, as illustrated in FIG. 6B, a length of the patch antennae 160A, 160B, 170A, 170B in the longitudinal direction is PL, and a length in the short direction is PS.

First, an optimal value of the length PS of the patch antennae 160A, 160B, 170A, 170B in the short direction is determined. Since a value of input impedance Z11 which is close to 50Ω is obtained when the length PS is 0.4 mm, it is now decided to perform simulation, fixing the length PS to 0.4 mm.

The length PL of the patch antennae 160A, 160B, 170A, 170B in the longitudinal direction was set to 1.0 mm, the length PS in the short direction to 0.4 mm, a thickness to 0.1 mm, and the diameter Sr of the slots 121A, 121B, 141A, 141B to 1.35 mm. In addition, a line length of the transmission lines 180A, 180B, 190A, 190B was set to λ/4 when a resonant frequency Fc was 78.0 GHz, line width W of the transmission lines 180A, 180B, 190A, 190B to 0.16 mm, and distance PD between the centers of the slots 121A, 121B to 2.0 mm. Note that a thickness of the transmission lines 180A, 180B, 190A, 190B is 0.1 mm.

In addition, a thickness of the dielectric layer 110 was set to 1 mm and a relative permittivity of the dielectric layer 110 to 3.8, a thickness of the dielectric layers 130 and 150 to 0.14 mm and a relative permittivity of the dielectric layers 130 and 150 to 4.4, and a thickness of copper foil used as the conductive layers 120 and 140 to 0.1 mm.

Here, to determine S11 parameter, S21 parameter, S41 parameter, and S42 parameter, the transmission line 190A was assigned to Port1, the transmission line 180A to Port2, the transmission line 190B to Port3, and the transmission line 180B to Port4.

In addition, as a model of a laminated waveguide for comparison, a model with both angles θ1, θ2 set to 0 degrees was used (See FIG. 8A).

FIG. 7A is a graph illustrating frequency characteristics of the S11 parameter, the S21 parameter, the S41 parameter, and the S42 parameter in the laminated waveguide for comparison. FIG. 7B is a graph illustrating frequency characteristics of the S11 parameter, the S21 parameter, the S41 parameter, and the S42 parameter in the laminated waveguide 100. FIG. 7C is a diagram summarizing contents of FIGS. 7A and 7B in a tabular format.

Here, as a bandwidth BW1, a band whose value of the S11 parameter was less than −10 dB was evaluated. As a bandwidth BW2, a band whose value of the S21 parameter was higher than −6 dB was evaluated. In addition, as a bandwidth BW4, a band whose values of the S41 parameter and the S42 parameters were both less than −22 dB was evaluated.

In the frequency characteristics of the S11 parameter, the S21 parameter, the S41 parameter, and the S42 parameter in the laminated waveguide for comparison as illustrated in FIG. 7A, the bandwidths BW1, BW2, BW4 were 8.0 GHz, 7.0 GHz, and 0.2 GHz, respectively.

Since the value of BW4 is small, in particular, it is seen that signals are transmitted between Port1 and Port4 and between Port2 and Port4. In other words, it is seen that Port4 interferes with a transmission line between Port1 and Port2.

FIG. 8A illustrates distribution of electric fields in the model of the laminated waveguide for comparison, and FIG. 8B is a view illustrating distribution of electric fields in the model of the laminated waveguide 100. As illustrated in FIG. 8A in the model of the laminated waveguide for comparison in which both angles θ1, θ2 are set to 0 degrees, the patch antennae 160A and 160B are parallel to the X-axis.

In FIG. 8A, an area with a larger electric field is illustrated in darker gray, and an area with a smaller electric field is illustrated in white or light gray.

As illustrated in FIG. 8A, in the model of the laminated waveguide for comparison, the strong electric field illustrated in dark gray is also generated at Port4 when a signal is conducted from Port1 to Port2, from which it is seen that Port4 interferes with the transmission line between Port1 and Port2.

As such, in the model of the laminated waveguide for comparison, it was learned that Port4 interfered with the transmission line between Port1 and Port2.

In contrast to this, in the frequency characteristics of the S11 parameter, the S21 parameter, the S41 parameter, and the S42 parameter in the laminated waveguide 100 as illustrated in FIG. 7B, the bandwidths BW1, BW2, BW4 were respectively 8.0 GHz, 2.0 GHz, and 3.7 GHz.

Since the value of BW4 is improved, in particular, it is seen that interference of the transmission line between Port1 and Port2 with Port4 is reduced and isolation is improved to some extent.

In addition, as illustrated in FIG. 8B, in the model of the laminated waveguide 100, no strong electric field expressed in dark gray is generated in Port4 when a signal is conducted from Port1 to Port2, from which it is seen that Port4 is isolated from the transmission line between Port1 and Port2.

As such, in the model of the laminated waveguide 100, it was learned that interference of the transmission line between Port1 and Port2 with Port4 was reduced and that isolation was improved to some extent.

The above results are as illustrated in FIG. 7C. In the laminated waveguide for comparison with both angles θ1, θ2 set to 0 degrees, the values of the S21 parameter, the S41 parameter, and the S42 parameter when the resonant frequency Fc was 78.0 GHz were −2.5 dB, 18.6 dB, and −15.1 dB, respectively.

In addition, the bandwidths BW1, BW2, and BW4 were 8.0 GHz, 7.0 GHz, and 0.2 GHz, respectively. A band BW in which all of the bandwidths BW1, BW2, and BW4 indicated a better value than the evaluation standard mentioned above was 0.2 GHz from 81.2 GHz to 81.4 GHz.

In contrast to this, in the laminated waveguide 100 with both angles θ1, θ2 set to 45 degrees, the values of the S21 parameter, the S41 parameter, and the S42 parameter when the resonant frequency Fc was 78.0 GHz were −2.9 dB, −24.9 dB, and −27.0 dB, respectively.

More specifically, it was learned that improvement of about 6 dB to about 12 dB was made compared with the laminated waveguide for comparison, and that isolation was improved.

In addition, the bandwidths BW1, BW2, and BW4 were 8.0 GHz, 6.0 GHz, and 3.7 GHz, respectively. A band BW in which all of the bandwidths BW1, BW2, and BW4 indicated a better value than the evaluation standard mentioned above was 3.7 GHz from 75.0 GHz to 78.7 GHz.

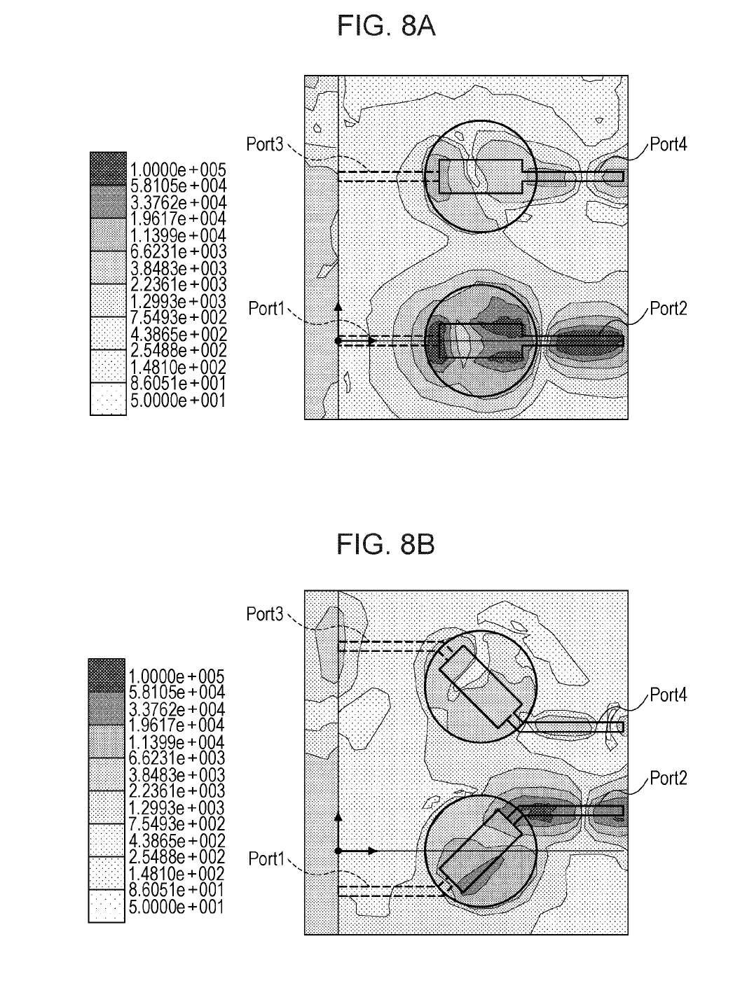

FIGS. 9A, 9B, and 9C are diagrams illustrating dependence of the resonant frequency Fc, the S parameters, BW1, BW2, BW4, and BW on a combination of the length PL and the diameter Sr.

As illustrated in FIG. 9A, the following was learned by changing the length PL of the patch antennae 160A, 160B, 170A, 170B in the longitudinal direction and the diameter Sr of the slots 121A, 121B, 141A, 141B.

When the diameter Sr was increased to 1.08 mm, 1.22 mm, and 1.35 mm with the length PL fixed to 1.0 mm, as illustrated in FIG. 9B, the resonant frequency Fc decreased and was 78.2 GHz when the diameter Sr was 1.35 mm.

Good values were obtained all for the S21 parameter, the S41 parameter, and the S42 parameter.

The value of BW1 increased as the diameter Sr of the slots 121A, 121B, 141A, 141B increased. Leakage of radio waves increasing, the value of BW1 increased. In contrast to this, there was not much change in the value of BW2.

In addition, as the diameter Sr of the slots 121A, 121B, 141A, 141B increased, the value of BW4 decreased. It is considered that this is because radio waves leaking to the outside of the laminated waveguide 100 from the slots 121A, 121B, 141A, 141B increased as the diameter Sr increased.

Note that the dependence of the BW1, BW2, BW3, BW4 on the diameter Sr is as illustrated in FIG. 9C.

In addition, when the length PL was increased to 1.0 mm, 1.1 mm, and 1.2 mm with the diameter Sr fixed to 1.35 mm, the resonant frequency Fc decreased.

Relatively good values were obtained for the S21 parameter, the S41 parameter, and the S42 parameter.

As described above, in the embodiment 1, the so-called wiring substrate structure was utilized to fabricate the laminated waveguide 100 which includes the waveguide built by the patch antennae 160A and 170A and the waveguide built by the patch antennae 160B and 170B.

Therefore, according to the embodiment 1, the laminated waveguide 100, the wireless communication module 50, and the wireless communication system 500 with the manufacturing cost reduced may be provided.

In addition, in the laminated waveguide 100 of the embodiment 1, as described above, the direction of the amplitude of the radio wave emitted by the patch antennae 160A and 170A was made orthogonal to the direction of the amplitude of the radio wave emitted by the patch antennae 160B and 170B.

Therefore, the laminated waveguide 100 may be provided wherein isolation of the waveguide built by the patch antennae 160A and 170A from the waveguide built by the patch antennae 160B and 170B is improved and interference between radio waves transmitted in the waveguides is reduced.

Note that a mode is not limited to the mode in which the direction of the amplitude of the radio wave emitted by the patch antennae 160A and 170A is orthogonal to the direction of the amplitude of the radio wave emitted by the patch antennae 160B and 170B.

It is learned from a simulation trend that interference between waveguides is considerably reduced and isolation is improved if angle formed by the direction of the amplitude of the radio wave emitted by the patch antennae 160A and 170A and the direction of the amplitude of the radio wave emitted by the patch antennae 160B and 170B is about 90 degrees±15 degrees.

In addition, for example, when the antenna 510 is mounted on one surface 100A and the MMIC module 51 and the MMIC drive circuit 52 are mounted on the other surface 100B, as illustrated in FIG. 1B, the laminated waveguide 100 is very effective, since a high-frequency signal generated by the MMIC module 51 and the MMIC drive circuit 52 is not easily received by the antenna 510.

In addition, in the above, the mode that the laminated waveguide 100 includes waveguides for two channels built by the patch antennae 160A, 160B, 170A, 170B and the slots 121A, 121B, 141A, 141B is described.

However, the laminated waveguide 100 may be in such a configuration that the laminated waveguide 100 has three or more waveguides by including more patch antennae and slots.

### Embodiment 2

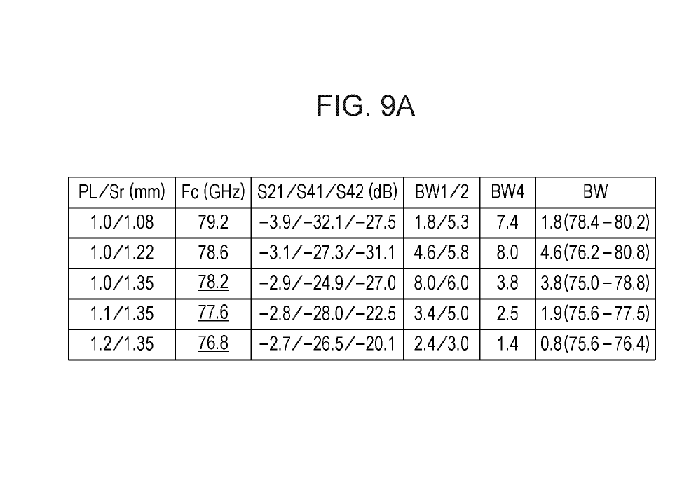

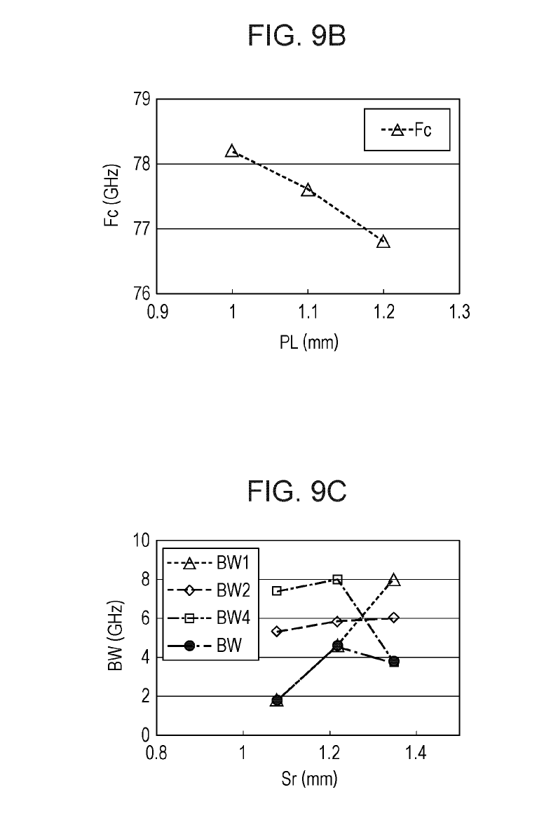

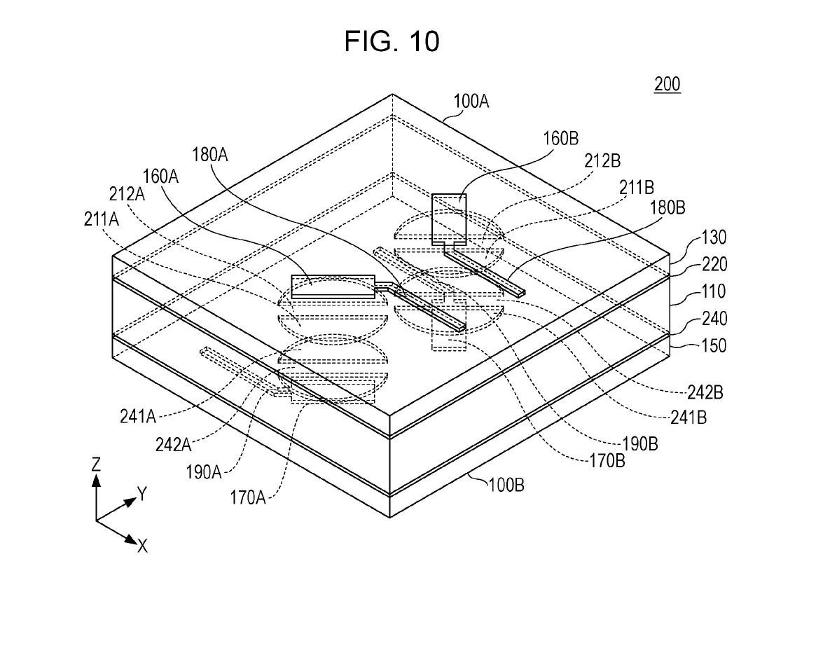

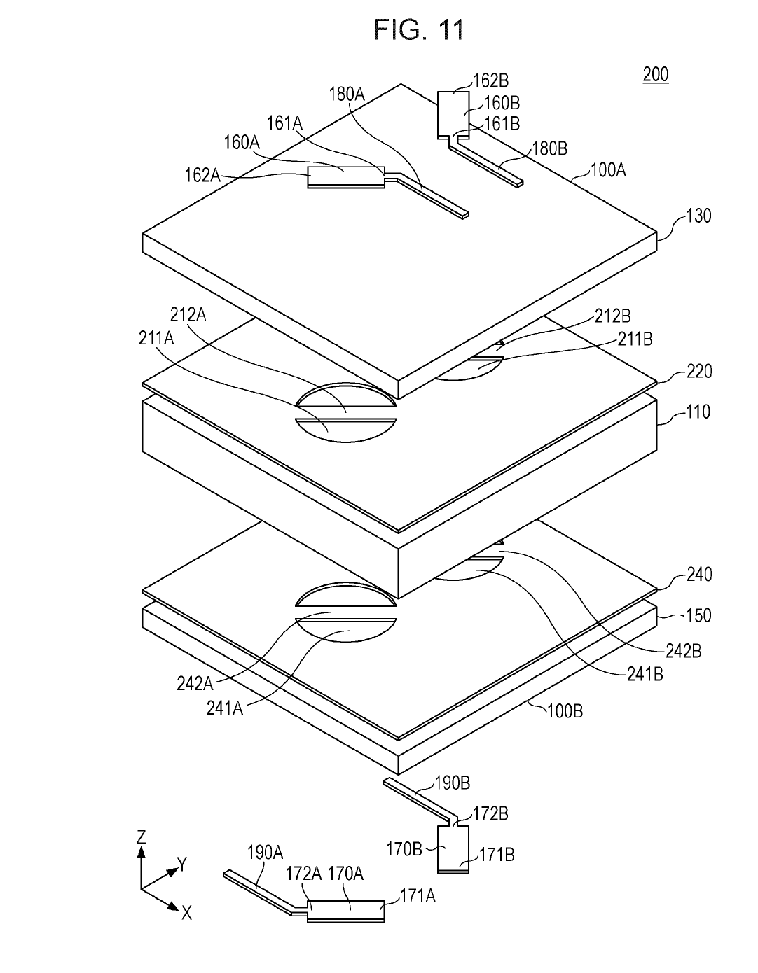

FIG. 10 is a perspective view illustrating a laminated waveguide 200 of an embodiment 2. FIG. 11 is a view illustrating an exploded state of the laminated waveguide 200 illustrated in FIG. 10. FIG. 12 is a top view illustrating the laminated waveguide 200. FIG. 13 is a view illustrating a cross section taken along the arrow XIII-XIII in FIG. 12. Note that an XYZ coordinate system (orthogonal coordinate system) is defined hereinafter, as illustrated in FIGS. 10 to 13.

The laminated waveguide 200 of the embodiment 2 has a configuration to which bridges are added that divide into two the slots 121A, 121B, 141A, 141B, respectively, of the laminated waveguide 100 of the embodiment 1. Thus, components similar to the components of the laminated waveguide 100 are assigned the same symbols and a description the components is omitted.

The laminated waveguide 200 includes a dielectric layer 110, a conductive layer 220, a dielectric layer 130, a conductive layer 240, a dielectric layer 150, patch antennae 160A, 160B, 170A, 170B, and transmission lines 180A, 180B, 190A, 190B.

Here, a mode in which the dielectric layer 110, the conductive layer 220, the dielectric layer 130, the conductive layer 240, the dielectric layer 150, the patch antenna 160A, 160B, 170A, 170B, and the transmission lines 180A, 180B, 190A, 190B are achieved by a wiring substrate of the FR4 standard is described.

The conductive layers 220 and 240 are formed on both sides of the dielectric layer 110.

The conductive layer 220 has slots 221A, 221B and bridges 222A, 222B. There are two each for the slots 221A and 221B. The bridges 222A and 222B are both examples of a first bridge.

The bridge 222A crosses between the two slots 221A, and the bridge 222B crosses between the two slots 221B. The slots 221A, 221B have a configuration in which the slots 121A, 121B of the embodiment 1 are respectively divided into two by the bridges 222A, 222B.

The bridge 222A is arranged such that the bridge 222A passes through the center of a virtual circle made by the two slots 221A and is orthogonal to the center axis L1. The virtual circle is equal to the opening of the slot 121A of the embodiment 1.

The bridge 222B is arranged such that the bridge 222B passes through the center of a virtual circle made by the two slots 221B and is orthogonal to the center axis L1. The virtual circle is equal to the opening of the slot 121B of the embodiment 1.

Thus, as illustrated in FIG. 12, the bridges 222A, 222B are respectively orthogonal to the patch antennae 160A, 160B (in the longitudinal direction) in a plan view.

The slots 221A, 221B which are respectively divided into two by such bridges 222A, 222B can be formed by patterning copper foil attached to a surface on the side in the positive Z-axis direction of a core material as the dielectric layer 110, for example, with the photolithography method and the wet etching method.

The conductive layer 240 has slots 241A, 241B and bridges 242A, 242B. There are two each for the slots 241A, 241B. The bridges 242A, 242B are both examples of a second bridge.

The bridge 242A crosses between the two slots 241A, and the bridge 242B crosses between the two slots 241B. The slots 241A, 241B have a configuration in which the slots 141A, 141B of the embodiment 1 are respectively divided into two by the bridges 242A, 242B.

The bridge 242A is arranged such that the bridge 242A passes through the center of a virtual circle made by the two slots 241A and is orthogonal to the center axis which is parallel to the longitudinal direction of the patch antenna 170A. The virtual circle is equal to the opening of the slot 141A of the embodiment 1.

The bridge 242B is arranged such that the bridge 242B passes through the center of a virtual circle made by the two slots 241B and is orthogonal to the center axis which is parallel to the longitudinal direction of the patch antenna 170B. The virtual circle is equal to the opening of the slot 141B of the embodiment 1.

Thus, the bridges 242A, 242B are respectively orthogonal to the patch antennae 170A, 170B (in the longitudinal direction) in a plan view.

The slots 241A, 241B are respectively aligned with the slots 221A, 221B in a plan view. In other words, the slots 241A, 241B are formed at positions corresponding to the slots 221A, 221B in a plan view. Thus, the bridges 242A, 242B are respectively aligned with the bridges 222A, 222B, in a plan view.

The slots 241A, 241B which are respectively divided into two by such bridges 242A, 242B can be formed by patterning the copper foil attached to the surface on the side in the positive Z-axis direction of a core material as the dielectric layer 110, for example, with the photolithography method and the wet etching method.

The bridges 222A, 222B extend in a direction orthogonal to a direction (direction in which the center axes L1, L2 extend) in which an amplitude of a radio wave emitted by the patch antennae 160A, 160B in the Z-axis direction fluctuates.

Thus, electric potentials of the bridges 222A, 222B are fixed in the direction in which the bridges 222A, 222B extend.

Therefore, even when an electric field Es leaks in the width direction of the patch antennae 160A, 160B, fluctuations of the electric field Es leaking in the width direction of the patch antennae 160A, 160B are limited by the bridges 222A, 222B. Thus, in the patch antennae 160A, 160B, the electric field Em in the direction in which the center axes L1, L2 extend is dominantly generated.

In addition, the bridge 222A passes through the center of the virtual circle formed by the two slots 241A, and the bridge 222B passes through the center of the virtual circle formed by the two slots 241B. Thus, the bridges 222A, 222B respectively pass through the center points of the patch antennae 160A, 160B in the longitudinal direction. Therefore, electric potentials of the bridges 222A, 222B are 0 V in the direction in which the bridges 222A, 222B extend.

Therefore, the bridges 222A, 222B, respectively, hardly limit an amplitude of an electric field which is generated in the longitudinal direction of the patch antennae 160A, 160B.

In addition, a relation between the bridges 242A, 242B and the patch antennae 170A, 170B is similar to a relation between the bridges 222A, 222B and the patch antennae 160A, 160B.

Thus, even when an electric field leaks in the width direction of the patch antennae 170A, 170B, fluctuations of the electric field Es leaking in the width direction of the patch antennae 170A, 170B are limited by the bridges 242A, 242B.

In addition, the bridges 242A, 242B, respectively, hardly limit an amplitude of an electric field which is generated in the longitudinal direction of the patch antennae 170A, 170B.

As described above, according to the embodiment 2, the patch antennae 160A and 170A and the patch antennae 160B and 170B being positioned such that amplitude directions of electric fields are orthogonal to each other in a plan view, isolation of a waveguide built by the patch antennae 160A and 170A from a waveguide built by the patch antennae 160B and 170B can be improved. This is similar to the laminated waveguide 100 of the embodiment 1.

In addition, according to the embodiment 2, in addition to the effect described above, even when an electric field leaks in the width direction of the patch antennae 160A, 160B, 170A, 170B, fluctuations in the electric field leaking in the width direction are limited by the bridges 222A, 222B, 242A, 242B.

The bridges 222A, 222B, 242A, 242B, respectively, hardly limit an amplitude of an electric field which is generated in the longitudinal direction of the patch antennae 160A, 160B, 170A, 170B.

Therefore, according to the embodiment 2, the laminated waveguide 200 can be provided in which the isolation of a waveguide built by the patch antennae 160A and 170A from a waveguide built by the patch antennae 160B and 170B is further improved.

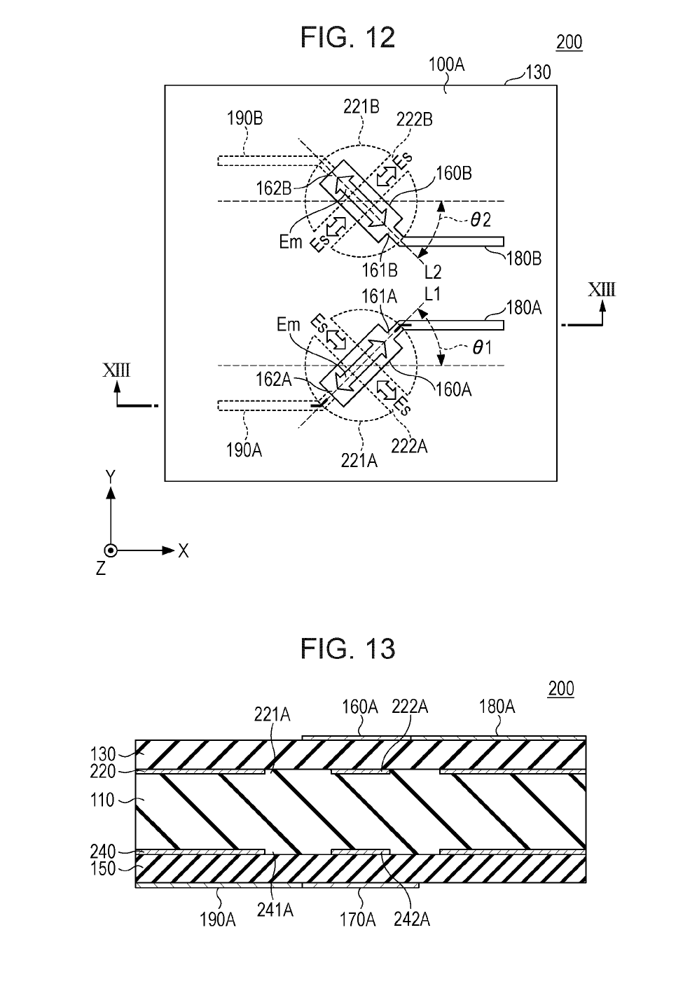

Simulation results are described hereinafter with reference to FIGS. 14A to 17.

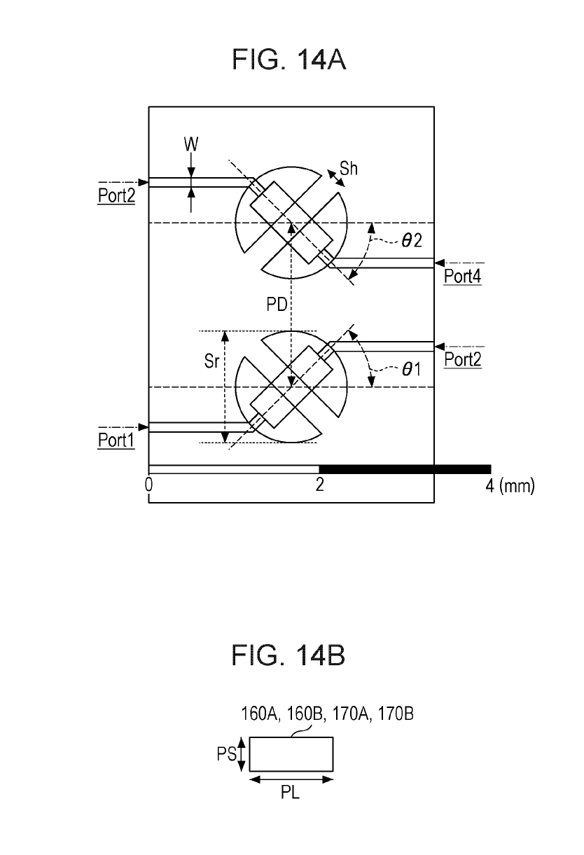

FIGS. 14A and 14B are views illustrating a simulation model of the laminated waveguide 200. FIG. 15 is a characteristic diagram illustrating a relationship between dimensions of a patch antenna 160A and input impedance Z11. As illustrated in FIG. 14A, diameter of the slots 221A, 221B, 241A, 241B is Sr, a distance between the centers of the slots 221A and 221B is PD, and line width of the transmission lines 180A, 180B, 190A, 190B is W. This is similar to FIG. 6B. In addition, width of the bridges 222A, 222B, 242A, 242B is Sh. Note that angles θ1, θ2 are the same as those illustrated in FIG. 4.

In addition, as illustrated in FIG. 14B, a length of the patch antennae 160A, 160B, 170A, 170B in the longitudinal direction is PL, and a length in the short direction is PS. This is similar to FIG. 6B.

First, a length of the patch antennae 160A, 160B, 170A, 170B in the longitudinal direction PL was set to 1.0 mm, a thickness of the patch antennae 160A, 160B, 170A, 170B was set to 0.1 mm, and a length in the short direction PS was changed. Then, characteristics of input impedance Z11 as illustrated in FIG. 15 were obtained.

As illustrated in FIG. 15, when the length in the short direction PS was changed from 0.4 mm to 0.9 mm, the input impedance Z11 changed from approximately 65Ω to approximately 108Ω. Since a value closest to 50Ω was obtained when the length PS was 0.4 mm, it was now decided to perform simulation, fixing the length PS to 0.4 mm.

Here, the length PL of the patch antennae 160A, 160B, 170A, 170B in the longitudinal direction was set to 1.0 mm, the length PS in the short direction to 0.4 mm, a thickness to 0.1 mm, and the diameter Sr of the slots 221A, 221B, 241A, 241B to 1.35 mm. In addition, line length of the transmission lines 180A, 180B, 190A, 190B was set to λ/4 when a resonant frequency Fc was 78.0 GHz, line width W of the transmission lines 180A, 180B, 190A, 190B to 0.03 mm, and distance PD between the centers of the slots 221A, 221B to 2.0 mm. Note that a thickness of the transmission lines 180A, 180B, 190A, 190B is 0.1 mm.

In addition, a thickness of the dielectric layer 110 was set to 1 mm and a relative permittivity of the dielectric layer 110 to 3.8, a thickness of the dielectric layers 130 and 150 to 0.14 mm and a relative permittivity of the dielectric layers 130 and 150 to 4.4, and a thickness of copper foil used as the conductive layers 120 and 140 to 0.1 mm.

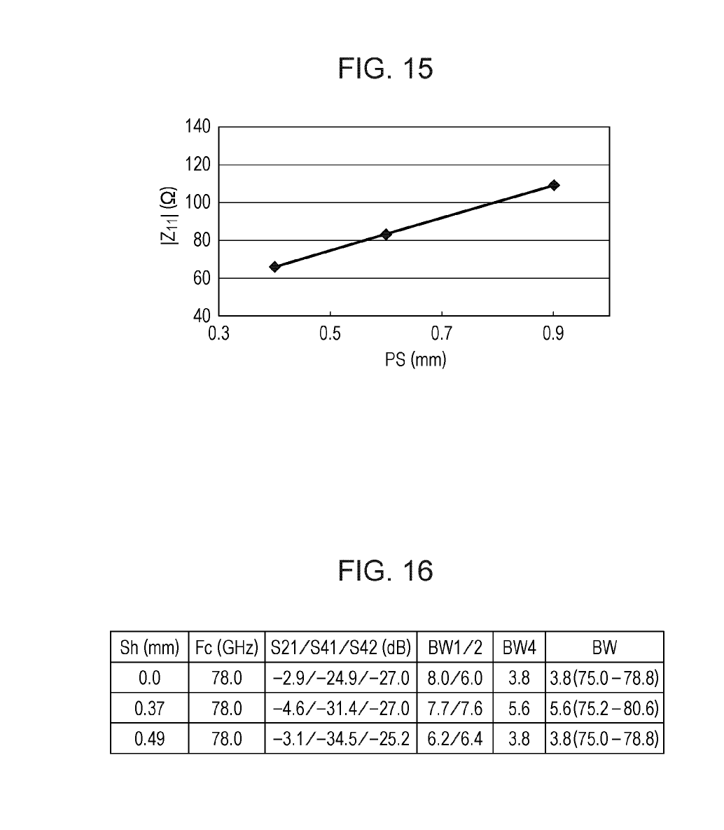

First, when the width Sh of the bridges 222A, 222B, 242A, 242B was changed, results illustrated in FIG. 16 were obtained.

FIG. 16 is a diagram summarizing in a tabular format simulation results obtained when width Sh is changed.

Here, a band a value of S11 parameter of which was less than −10 dB as a bandwidth BW1 was evaluated. As a bandwidth BW2, a band a value of the S21 parameter of which was higher than −6 dB was evaluated. In addition, as a bandwidth BW4, a band values of S41 parameter and S42 parameter of which were both less than −22 dB was evaluated.

In the laminated waveguide 200, a simulation was performed by setting the width Sh to 0 mm, 0.37 mm, and 0.49 mm. Note that the width Sh being 0 mm is a case in which the bridges 222A, 222B, 242A, 242B are not present, and the case corresponds to the configuration of the laminated waveguide 100 of the embodiment 1.

When the width Sh is 0 mm, at a point at which the resonant frequency Fc was 78.0 GHz, the values of the S21 parameter, the S41 parameter, and the S42 parameter were −2.9 dB, −24.9 dB, and −27.0 dB, respectively. In addition, the BW1, the BW2, and the BW4 were 8.0 GHz, 6.0 GHz, and 3.8 GHz, respectively. Thus, a band BW in which all of the bandwidths BW1, BW2, and BW4 indicated a better value than the evaluation standard mentioned above was 3.8 GHz from 75.0 GHz to 78.8 GHz.

When the width Sh was 0.37 mm, at a point where the resonant frequency Fc was 78.0 GHz, the values of the S21 parameter, the S41 parameter, and the S42 parameter were −4.6 dB, −31.4 dB, and −27.0 dB, respectively. In addition, the BW1, the BW2, and the BW4 were 7.7 GHz, 7.6 GHz, and 5.6 GHz, respectively. Thus, a band BW in which all of the bandwidths BW1, BW2, and BW4 indicated a better value than the evaluation standard mentioned above was 5.6 GHz from 75.2 GHz to 80.6 GHz.

When the width Sh is 0.49 mm, at a point where the resonant frequency Fc was 78.0 GHz, the values of the S21 parameter, the S41 parameter, and the S42 parameter were −3.1 dB, −34.5 dB, and −25.2 dB, respectively. In addition, the BW1, the BW2, and the BW4 were 6.2 GHz, 6.4 GHz, and 3.8 GHz, respectively. Thus, a band BW in which all of the bandwidths BW1, BW2, and BW4 indicated a better value than the evaluation standard mentioned above was 3.8 GHz from 75.0 GHz to 78.8 GHz.

As described above, when the width Sh was 0.37 mm, the BW exhibited the best value of 5.6. The BWs of when the width Sh was 0 mm and when the width Sh was 0.49 mm were both 3.8.

With this, it was learned that in order to obtain the good isolation characteristics, it is important to set the width Sh of the bridges 222A, 222B, 242A, 242B to appropriate width which is not too thick.

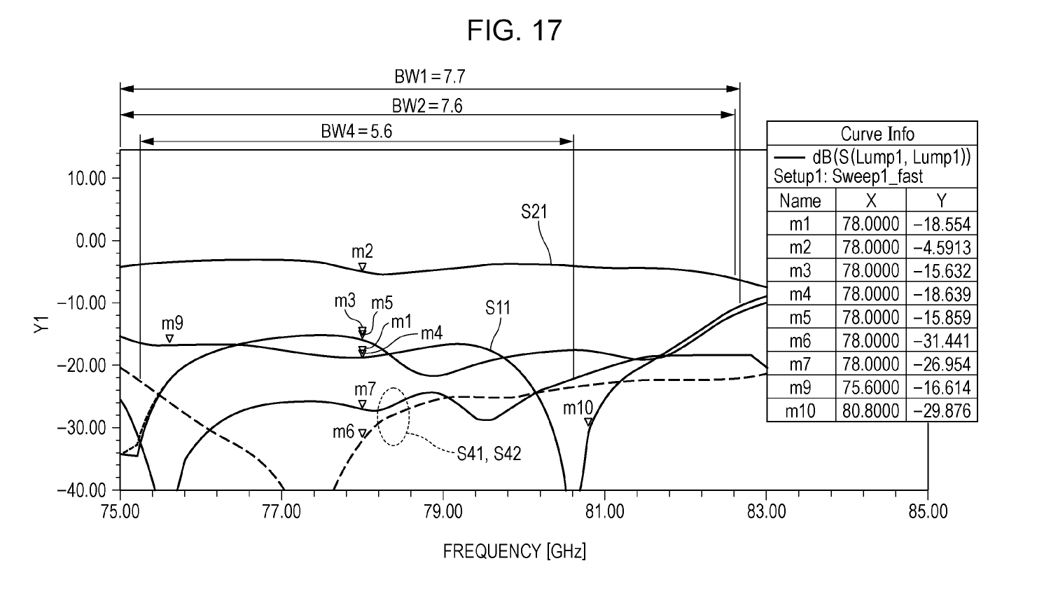

Then, S parameters were determined by setting the width Sh of the bridges 222A, 222B, 242A, 242B to 0.37 mm, as illustrated in FIG. 17.

FIG. 17 is a graph illustrating the frequency characteristics of the S11 parameter, the S21 parameter, the S41 parameter, and the S42 parameter in the laminated waveguide 200.

In the frequency characteristics of the S11 parameter, the S21 parameter, the S41 parameter, and the S42 parameter in the laminated waveguide 200 as illustrated in FIG. 17, the bandwidths BW1, BW2, BW4 were 7.7 GHz, 7.6 GHz, and 5.6 GHz, respectively.

Since the BW2 and the BW4 are improved, in particular, it is learned that interference of the transmission line between Port1 and Port2 with Port4 is more reduced than in the laminated waveguide 100 of the embodiment 1, and the isolation is improved.

As such, in the model of the laminated waveguide 200, it is learned that interference of the transmission line between Port1 and Port2 with Port4 is more reduced than in the laminated waveguide 100 of the embodiment 1, and the isolation is improved.

As described above, according to the embodiment 2, the bridges 222A, 222B, 242A, 242B being provided, fluctuations in an electric field which leaks in the width direction are limited even when the electric field leaks in the width direction of the patch antennae 160A, 160B, 170A, 170B, and thus the good isolation characteristics can be obtained.

Therefore, according to the embodiment 2, the laminated waveguide 200 in which the isolation of a waveguide built by the patch antennae 160A and 170A from a waveguide built by the patch antennae 160B and 170B is further improved can be provided.

Note that in the above, the mode in which the bridges 222A, 222B, 242A, 242B are formed in each of the slots 221A, 221B, 241A, 241B is described. However, the bridges 222A, 242A may be respectively formed only in the slots 221A, 241A, and the bridges 222B, 242B may not be formed in the slots 221B, 241B.

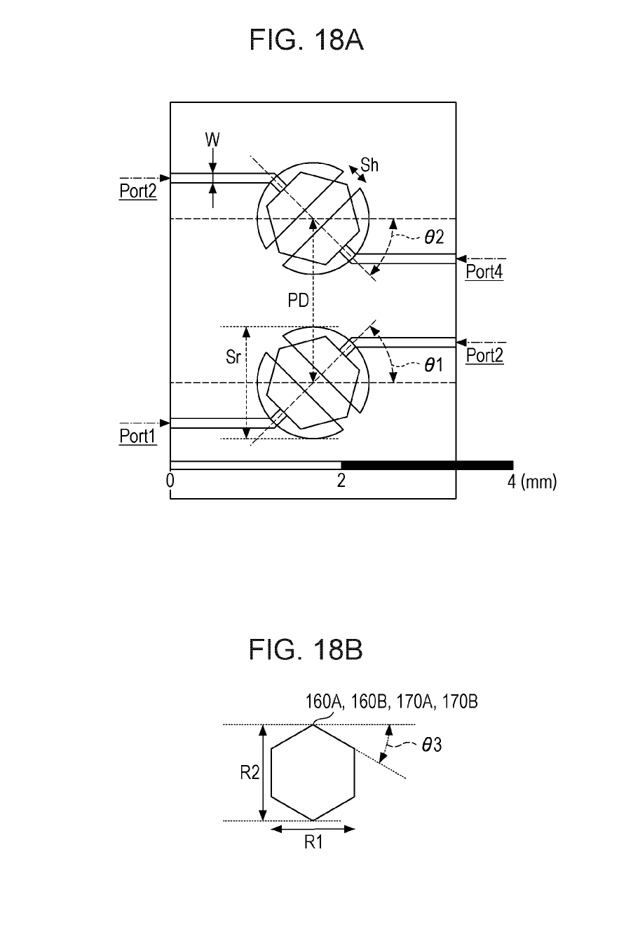

Simulation results of a laminated waveguide according to a variant of the embodiment 2 are described hereinafter with reference to FIGS. 18A to 20.

FIGS. 18A and 18B are views illustrating a simulation model of the laminated waveguide according to the variant of the embodiment 2.

The laminated waveguide of the variant of the embodiment 2 has the shape of the patch antennae 160A, 160B, 170A, 170B of the laminated waveguide 200 of the embodiment 2 that is changed from the rectangle to a regular hexagon. In the following, each component of the laminated waveguide of the variant is described using the same symbols as the respective components of the laminated waveguide 200 of the embodiment 2.

As illustrated in FIG. 18A, diameter of slots 221A, 221B, 241A, 241B is Sr, a distance between the centers of the slots 221A and 221B is PD, and line width of the transmission lines 180A, 180B, 190A, 190B is W. In addition, width of bridges 222A, 222B, 242A, 242B is Sh. Note that angles θ|, θλ are the same as those illustrated in FIG. 4.

In addition, as illustrated in FIG. 18B, a length in a direction in which an amplitude of an electric field of the hexagonal patch antennae 160A, 160B, 170A, 170B is generated is R1, and a length in a direction orthogonal to the length R1 is R2. In addition, angle formed by four sides which are not orthogonal to the direction (direction of the length R1) in which the amplitude of the electric field of the hexagonal patch antennae 160A, 160B, 170A, 170B is generated is θ3.

Here, the length R1 was set to 1.0 mm, the length R2 to 1.15 mm, the angle θ3 to 30 degrees, a thickness to 0.1 mm, and diameter Sr of the slots 221A, 221B, 241A, 241BB to 1.35 mm. In addition, a line length of the transmission lines 180A, 180B, 190A, 190B was set to λ/4 of when a resonant frequency Fc was 78.0 GHz, line width W of the transmission lines 180A, 180B, 190A, 190B to 0.03 mm, and distance PD between the slots 221A and 221B to 2.0 mm. Note that a thickness of the transmission lines 180A, 180B, 190A, 190B is 0.1 mm.

In addition, a thickness of the dielectric layer 110 was set to 1 mm and a relative permittivity of the dielectric layer 110 to 3.8, a thickness of the dielectric layers 130 and 150 to 0.14 mm and a relative permittivity the dielectric layers 130 and 150 to 4.4, and a thickness of copper foil used as the conductive layers 120 and 140 to 0.1 mm.

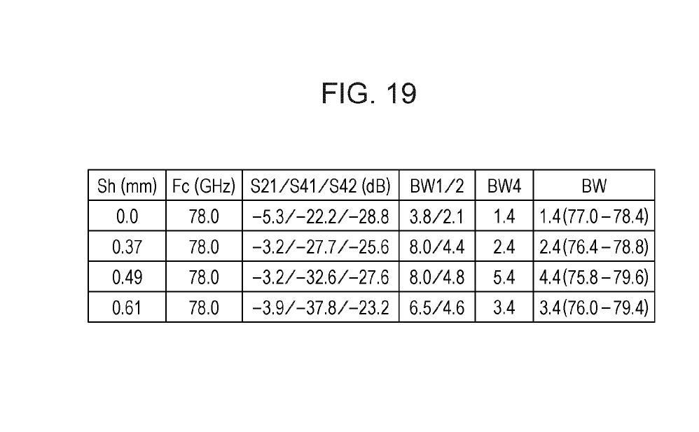

First, when width Sh of the bridges 222A, 222B, 242A, 242B was changed to 0.0 mm, 0.37 mm, 0.49 mm, and 0.61 mm, results as illustrated in FIG. 19 were obtained.

Note that the width Sh being 0 mm is a case in which the bridges 222A, 222B, 242A, 242B are not present.

FIG. 19 is a diagram summarizing in a tabular format simulation results when the width Sh was changed in the laminated waveguide of the variant of the embodiment 2.

Here, as a bandwidth BW1, a band whose value of S11 parameter was less than −10 dB was evaluated. As a bandwidth BW2, a band whose value of S21 parameter was higher than −6 dB was evaluated. In addition, as a bandwidth BW4, a band whose values of S41 parameter and S42 parameters were both less than −22 dB was evaluated.

When the width Sh was 0 mm, at a point where the resonant frequency Fc was 78.0 GHz, the values of the S21 parameter, the S41 parameter, and the S42 parameter were −5.3 dB, −22.2 dB, and −28.8 dB, respectively. In addition, the BW1, the BW2, and the BW4 were 3.8 GHz, 2.1 GHz, and 1.4 GHz, respectively. Thus, a band BW in which all of the bandwidths BW1, BW2, and BW4 indicated a better value than the evaluation standard mentioned above was 1.4 GHz from 77.0 GHz to 78.4 GHz.

When the width Sh was 0.37 mm, at a point where the resonant frequency Fc was 78.0 GHz, the values of the S21 parameter, the S41 parameter, and the S42 parameter were −3.2 dB, −27.7 dB, and −25.6 dB, respectively. In addition, the BW1, the BW2, and the BW4 were 8.0 GHz, 4.4 GHz, and 2.4 GHz, respectively. Thus, a band BW in which all of the bandwidths BW1, BW2, and BW4 indicated a better value than the evaluation standard mentioned above was 2.4 GHz from 76.4 GHz to 78.8 GHz.

When the width Sh was 0.49 mm, at a point where the resonant frequency Fc was 78.0 GHz, the values of the S21 parameter, the S41 parameter, and the S42 parameter were −3.2 dB, −32.6 dB, and −27.6 dB, respectively. In addition, the BW1, the BW2, and the BW4 were 8.0 GHz, 4.8 GHz, and 5.4 GHz, respectively. Thus, a band BW in which all of the bandwidths BW1, BW2, and BW4 indicated a better value than the evaluation standard mentioned above was 4.4 GHz from 75.8 GHz to 79.6 GHz.

When the width Sh was 0.61 mm, at a point where the resonant frequency Fc was 78.0 GHz, the values of the S21 parameter, the S41 parameter, and the S42 parameter were −3.9 dB, −37.8 dB, and −23.2 dB, respectively. In addition, the BW1, the BW2, and the BW4 were 6.5 GHz, 4.6 GHz, and 3.4 GHz, respectively. Thus, a band BW in which all of the bandwidths BW1, BW2, and BW4 indicated a better value than the evaluation standard mentioned above was 3.4 GHz from 76.0 GHz to 79.4 GHz.

As described above, when the width Sh was 0.49 mm, the BW exhibited the best value of 4.4.

With this, it is learned that in order to obtain the good isolation characteristics, it is important to set the width Sh of the bridges 222A, 222B, 242A, 242B to appropriate width which is not too thick.

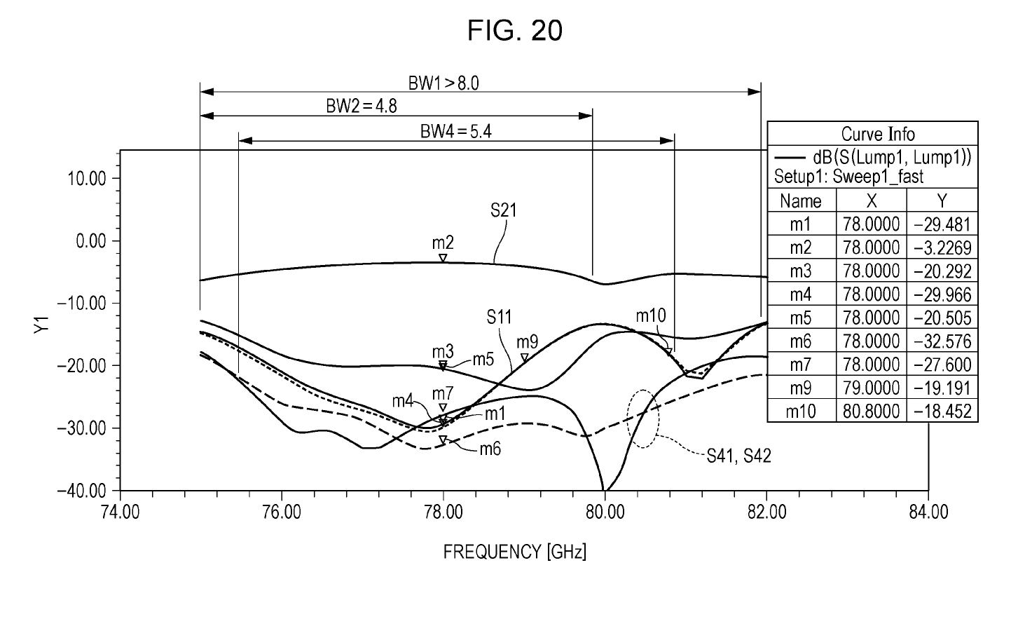

FIG. 20 is a graph illustrating the frequency characteristics of the S11 parameter, the S21 parameter, the S41 parameter, and the S42 parameter when the width Sh is set to 0.49 mm in the laminated waveguide of the variant of the embodiment 2.

Here, as a bandwidth BW1, a band whose value of S11 parameter was less than −10 dB was evaluated. As a bandwidth BW2, a band whose value of S21 parameter was higher than −6 dB was evaluated. In addition, as a bandwidth BW4, a band whose values of S41 parameter and S42 parameter were both less than −22 dB was evaluated.

In the frequency characteristics of the S11 parameter, the S21 parameter, the S41 parameter, and the S42 parameter illustrated in FIG. 20, the bandwidths BW1, BW2, BW4 were 8.0 GHz or higher (BW1≧8.0), 4.8 GHz, and 5.4 GHz, respectively.

Since the BW2 and the BW4 are improved, in particular, it is learned that interference of the transmission line between Port1 and Port2 with Port4 is more reduced than in the laminated waveguide 100 of the embodiment 1, and the isolation is improved.

As such, it is learned in the model of the laminated waveguide of the variant of the embodiment 2 that interference of the transmission line between Port1 and Port2 with Port4 is more reduced than in the laminated waveguide 100 of the embodiment 1 and isolation is further improved.

As described above, according the variant of the embodiment 2, the hexagonal bridges 222A, 222B, 242A, 242B being provided, fluctuations of an electric field leaking in the width direction are limited even when the electric field leaks in the width direction of the patch antennae 160A, 160B, 170A, 170B, and good isolation characteristics can be obtained.

Therefore, according to the variant of the embodiment 2, the laminated waveguide can be provided in which the isolation of a waveguide built by the hexagonal patch antennae 160A and 170A from a waveguide built by the hexagonal patch antennae 160B and 170B is further improved.

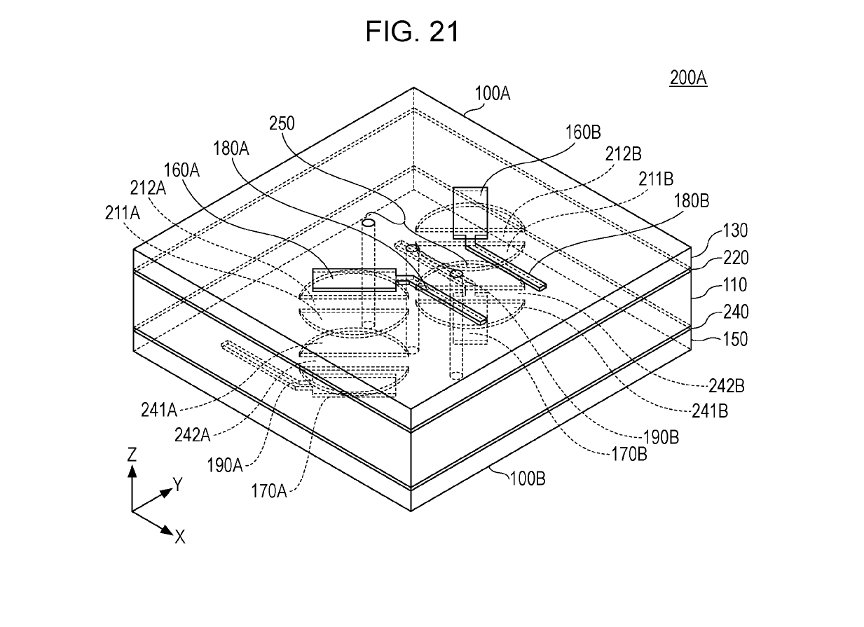

FIG. 21 is a view illustrating a configuration of a laminated waveguide 200A according to the variant of the embodiment 2.

The laminated waveguide 200A is the laminated waveguide 200 illustrated in FIG. 10 to which shield pins 250 are added.

In FIG. 21, the number of shield pins 250 is three, the shield pins being arranged along the direction of the X-axis between waveguides for two channels that are built by patch antennae 160A, 160B, 170A, 170B and slots 221A, 221B, 241A 241B. The shield pins 250 penetrate through a dielectric layer 110, a conductive layer 220, a dielectric layer 130, a conductive layer 240, and a dielectric layer 150 in the Z-axis direction, and are connected to the conductive layer 120 and the conductive layer 140. Both ends of the shield pins 250 appear on surfaces of the dielectric layers 130 and 150.

Use of such shield pins 250 can improve the isolation characteristics between waveguides for different channels.

Note that both ends of the shield pins 250 may not appear on the dielectric layers 130 and 150, and may be formed between the conductive layers 220 and 240.

While the laminated waveguides, the wireless modules, and the wireless systems of illustrative embodiments of the present disclosure are described above, the present disclosure is not to be limited to the specifically disclosed embodiments, and various variations or modifications may be made without deviating from the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A laminated waveguide, comprising:
a first dielectric layer;
a first conductive layer provided on a first surface of the first dielectric layer and having a first slot and a second slot;
a second conductive layer provided on a second surface of the first dielectric layer opposite to the first surface and having a third slot and a fourth slot that are formed at positions respectively corresponding to the first slot and the second slot in plan view;
a second dielectric layer laminated on the first dielectric layer with the first conductive layer interposed in between;
a third dielectric layer laminated on the first dielectric layer with the second conductive layer interposed in between;
a first patch antenna formed on the second dielectric layer such that the first patch antenna is located within an opening of the first slot in plan view;
a second patch antenna formed on the second dielectric layer such that the second patch antenna is located within an opening of the second slot in plan view;
a third patch antenna formed on the third dielectric layer such that the third patch antenna is located within an opening of the third slot in plan view;
a fourth patch antenna formed on the third dielectric layer such that the fourth patch antenna is located within an opening of the fourth slot in plan view;
a first transmission line formed on the second dielectric layer and connected to a first end of the first patch antenna;
a second transmission line formed on the second dielectric layer and connected to a first end of the second patch antenna;
a third transmission line formed on the third dielectric layer and connected to an end of the third patch antenna on the same side as a second end of the first patch antenna opposite to the first end in plan view; and
a fourth transmission line formed on the third dielectric layer and connected to an end of the fourth patch antenna on the same side as a second end of the second patch antenna opposite to the first end in plan view,
wherein a pair of the first patch antenna and the third patch antenna, and another pair of the second patch antenna and the fourth patch antenna are arranged to form an angle between a first amplitude direction of electric fields of the pair and a second amplitude direction of electric fields of the another pair in plan view so as to suppress interference between the pair and the another pair.

2. The laminated waveguide according to claim 1, wherein the pair and the another pair are arranged such that the first amplitude direction is orthogonal to the second amplitude direction.

3. The laminated waveguide according to claim 1, wherein the angle formed between the first amplitude direction and the second amplitude direction is 90 degrees±15 degrees.

4. The laminated waveguide according to claim 1,
wherein the first conductive layer comprises a first bridge that divides the first slot into two or more slot sections; and
a direction in which the first bridge extends is different from the first amplitude direction.

5. The laminated waveguide according to claim 4, wherein the direction in which the first bridge extends is a direction at an angle of 90 degrees from the first amplitude direction in plan view.

6. The laminated waveguide according to claim 4,
wherein the second conductive layer has a second bridge that divides the third slot into two or more slot sections; and
a direction in which the second bridge extends is different from the second amplitude direction.

7. The laminated waveguide according to claim 6, wherein the direction in which the second bridge extends is a direction at an angle of 90 degrees from to the second amplitude direction in plan view.

8. The laminated waveguide according to claim 1, wherein the first patch antenna, the second patch antenna, the third patch antenna, and the fourth patch antenna each have a rectangular or polygonal shape in plan view.

9. The laminated waveguide according to claim 1, wherein each pair of the first patch antenna and the third patch antenna, and the second patch antenna and fourth patch antenna have the same shape.

10. The laminated waveguide according to claim 1, wherein the first transmission line, the second transmission line, the third transmission line, and the fourth transmission line are microstrip lines or coplanar waveguides.

11. The laminated waveguide according to claim 1, further comprising one or more conductive shield pins penetrating through the first dielectric layer, the first conductive layer, and the second conductive layer in a lamination direction, and formed between the first slot and the second slot, and the third slot and the fourth slot in plan view.

12. A wireless module, comprising:
a laminated waveguide including
a dielectric layer,
a first patch antenna and a second patch antenna formed on a first face of the dielectric layer,
a third patch antenna and a fourth patch antenna formed on a second face of the dielectric layer, the first face being opposite to the second surface,
a first transmission line and a second transmission line formed on the dielectric layer and connected to a first end of the first patch antenna and a first end of the second patch antenna, respectively, and
a third transmission line and a fourth transmission line formed on the dielectric layer and connected to a first end of the third patch antenna and a first end of the fourth patch antenna, respectively,
wherein a pair of the first patch antenna and the third patch antenna, and another pair of the second patch antenna and the fourth patch antenna are arranged to form an angle between a first amplitude direction of electric fields of the pair and a second amplitude direction of electric fields of the another pair in plan view so as to suppress interference between the pair and the another pair; and
an integrated circuit connected to the first transmission line and the second transmission line or the third transmission line and the fourth transmission line of the laminated waveguide, and configured to perform wireless front-end processing of a transmission signal and a reception signal transmitted through the laminated waveguide.

13. A wireless system, comprising:
a laminated waveguide including
a first dielectric layer,
a first conductive layer provided on a first surface of the first dielectric layer and having a first slot and a second slot,
a second conductive layer provided on a second surface of the first dielectric layer opposite to the first surface and having a third slot and a fourth slot that are formed at positions respectively corresponding to the first slot and the second slot in plan view,
a second dielectric layer laminated on the first dielectric layer with the first conductive layer interposed in between,
a third dielectric layer laminated on the first dielectric layer with the second conductive layer interposed in between,
a first patch antenna formed on the second dielectric layer such that the first patch antenna is located within an opening of the first slot in plan view,
a second patch antenna formed on the second dielectric layer such that the second patch antenna is located within an opening of the second slot in plan view,
a third patch antenna formed on the third dielectric layer such that the third patch antenna is located within an opening of the third slot in plan view,
a fourth patch antenna formed on the third dielectric layer such that the fourth patch antenna is located within an opening of the fourth slot in plan view,
a first transmission line formed on the second dielectric layer and connected to a first end of the first patch antenna,
a second transmission line formed on the second dielectric layer and connected to a first end of the second patch antenna,
a third transmission line formed on the third dielectric layer and connected to an end of the third patch antenna on the same side as a second end of the first patch antenna opposite to the first end in plan view, and
a fourth transmission line formed on the third dielectric layer and connected to an end of the fourth patch antenna on the same side as a second end of the second patch antenna opposite to the first end in plan view,
wherein a pair of the first patch antenna and the third patch antenna, and the another pair of the second patch antenna and the fourth patch antenna are arranged to form an angle between a first amplitude direction of electric fields of the pair and a second amplitude direction of electric fields of the another pair form a non-zero angle in plan view so as to suppress interference between the pair and the another pair;
an antenna connected to the first transmission line and the second transmission line of the laminated waveguide and configured to emit a millimeter wave;
an integrated circuit connected to the third transmission line and the fourth transmission line of the laminated waveguide and configured to perform wireless front-end processing of a millimeter wave signal transmitted through the laminated waveguide; and
a signal processing section connected to the integrated circuit and configured to perform baseband signal processing of the millimeter wave signal.

14. The wireless system according to claim 13,
wherein the antennae are mounted on the second dielectric layer, and
the integrated circuit is mounted on the third dielectric layer.
